(19) United States
(12) Patent Application Publication
(10) Pub. No.: US 2026/0131185 A1
(43) Pub. Date: May 14, 2026

(54) Load Bearing Hinge Joint

(71) Applicant: Jeff Gillespie, Naples, FL (US)

(72) Inventor: Jeff Gillespie, Naples, FL (US)

(21) Appl. No.: 19/445,340

(22) Filed: Jan. 9, 2026

Related U.S. Application Data
(63) Continuation-in-part of application No. 18/375,614, filed on Oct. 2, 2023, now Pat. No. 12,544,616.

(51) Int. Cl. A63B 21/16; F16C 11/04

(52) U.S. Cl. CPC A63B 21/1636; F16C 11/045; A63B 2210/50

(57) ABSTRACT

A load bearing hinge joint, including a first arm member, a second arm member and fastening means for pivotally interconnecting the second arm member to the first arm member, wherein the fastening means are positioned on a first side surface of the first arm member and on a second side surface of the first arm member; a support seat, wherein the support seat is positioned on atop surface of the first arm proximate to a second end of the first arm, wherein the second end is distal to and opposite facing a first end of the first arm member and wherein the support seat is configured to receive and support a bottom portion of the second arm member. The first arm member further including a shoulder positioned on a top surface of the first arm member proximate to the support seat, wherein the shoulder is configured to act as a fulcrum to facilitate a pivotal rotation of the second arm member relative to the first arm member at a pivot point.

### CROSS-REFERENCE TO RELATED APPLICATIONS

This application is a continuation-in-part of U.S. patent application Ser. No. 18/375,614, filed Oct. 2, 2023, which is incorporated herein by reference in its entirety. This application claims the benefit of the filing date of the above-identified application pursuant to 35 U.S.C. § 120 for subject matter disclosed therein.

### BACKGROUND OF THE INVENTION

### 1. Field of the Invention

The present disclosure relates generally to a hinged joint assembly. More particularly, the invention relates to a hinge joint assembly for heavy load bearing applications, including for example, stairs, ladders, chairs, exercise pull-up devices and the like.

### 2. Description of the Related Art

A hinge is a mechanical bearing that connects two objects for allowing an angle of rotation between the two objects. It is generally known to utilize a hinge to allow for two or more objects to rotate about a fixed axis of rotation.

Hinges known in the art include AU Appl. No. 2015294997 B2 (to Frank) for an improved hinge. The hinge includes a mounting plate, a first arm pivotally coupled to a panel mounting element, a second arm pivotally coupled in a scissoring manner with the first arm by a main pivot, and a third arm pivotally coupled to the second arm at a location between a first end of the second arm and the main point.

The prior art also teaches U.S. Pat. No. 4,864,691 (to Gidseg et al.) for a hinge assembly. The hinge comprises a first hinge assembly which comprises a first hinge bracket attachable to the structural member, a second hinge bracket attachable to the barrier member, a first hinge member mounted for rotation with the second hinge mounting bracket and a second hinge member mounted for rotation with the first hinge member. Both hinge members have correspondingly configured engaging surfaces which permit staged rotation between the hinge members. The first hinge assembly connects to a lower portion of the barrier member to the structural member and is responsible for bearing substantially all of the weight of the barrier member.

U.S. Pat. No. 2,162,650 (to Stephens) discloses a weight bearing hinge. In particular the invention teaches a leaf hinge having a ball and socket joint constructed to allow the weight of the hinged article to be supported upon the ball.

In the context of a hinge joint it is desirable to have a reliable and effective hinge joint assembly that creates an angle of rotation between two objects and may be utilized in a variety of heavy load bearing applications.

### SUMMARY OF THE INVENTION

In accordance with the present invention, a load bearing hinge of the invention is disclosed. In one embodiment, the invention teaches two interconnected arm members. In a preferred embodiment, a first arm member includes a shoulder or step, mounted along a length, of a surface of the first arm and at a distance from an end of the first arm. The step or shoulder is preferably permanently affixed to the surface of the first arm. In one embodiment, the step or shoulder is welded to the surface of the first arm. In yet another embodiment, the first arm and step or shoulder are formed from a single injection mold.

In an open or extended configuration, a bottom end, of the second arm of the load bearing hinge, rests on a surface of the first arm, along a length of the surface of the first arm, such that a bottom end of the second arm abuts the shoulder. The shoulder thereby creates a fulcrum or pivot point between the first arm and second arm of the load bearing hinge of the invention.

In a preferred embodiment, a fastener is used to connect the first arm to the second arm and the fastener extends across the step or shoulder.

In a closed or collapsed configuration, the second arm of the load bearing hinge, rests on a top surface of the shoulder or step. The second arm is positioned on the shoulder or step and at a distance from the first arm. In the closed or collapsed configuration, the second arm runs in a longitudinal direction, parallel to the first arm.

In a preferred embodiment, the bottom end of the second arm is flush with an end of the shoulder or step. The step or shoulder thereby creates a fulcrum or pivot point between the first arm and second arm of the load bearing hinge of the invention.

Thus, when the second arm of the load bearing hinge rotates about the step of shoulder to an open or expanded position, the bottom of the second arm locks into position abutting an end of the should or step on the surface of the first arm.

An aspect of the invention is that it easily and readily allows a user to collapse or expand a device using the load bearing hinge joint.

An object of the load bearing hinge joint of the invention is that it is secure and provides a stable and strong attachment for supporting a heavy weight.

An advantage of the load bearing hinge joint of the invention is that it improves hinges known in the art that are prone to slippage and prevents dislodgment.

Another advantage of the load bearing hinge joint of the invention is that it is safe economical and easy to use.

These and other aspects and advantages of the present disclosure will become apparent from the following detailed description of preferred embodiments of the invention considered in conjunction with the accompanying drawings, in which like drawings represent like components. It is to be understood, however, that the drawings are designed solely for purposes of illustration and not as a definition of the limits of the disclosure, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE INVENTION

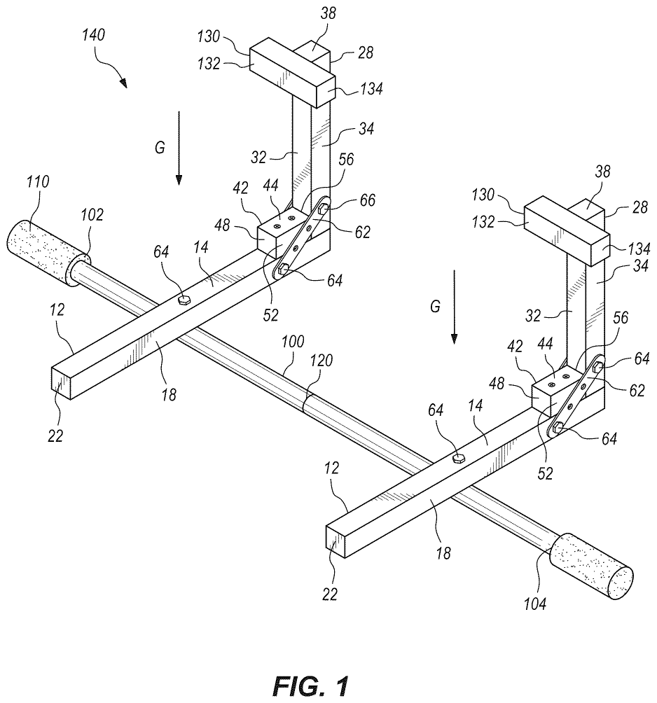

FIG. 1 is a front perspective side view of the load bearing hinge joint of the present invention affixed to a bar forming an exercise pull-up device.

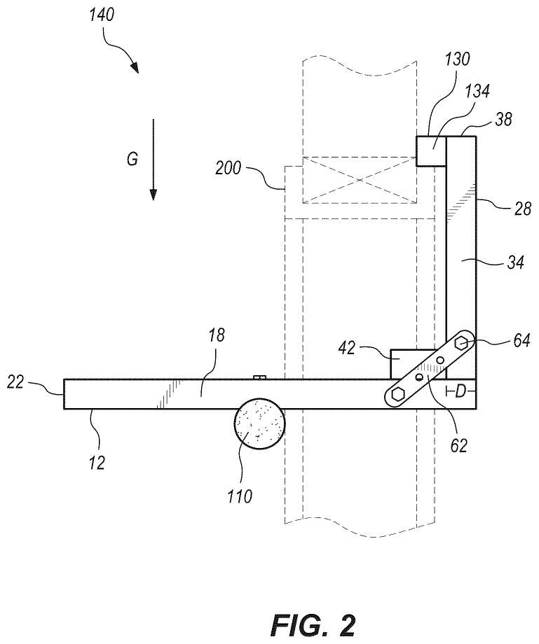

FIG. 2 is a side view of the load bearing hinge joint incorporated in an exercise pull-up device as shown in FIG. 1 for use in conjunction with a door frame.

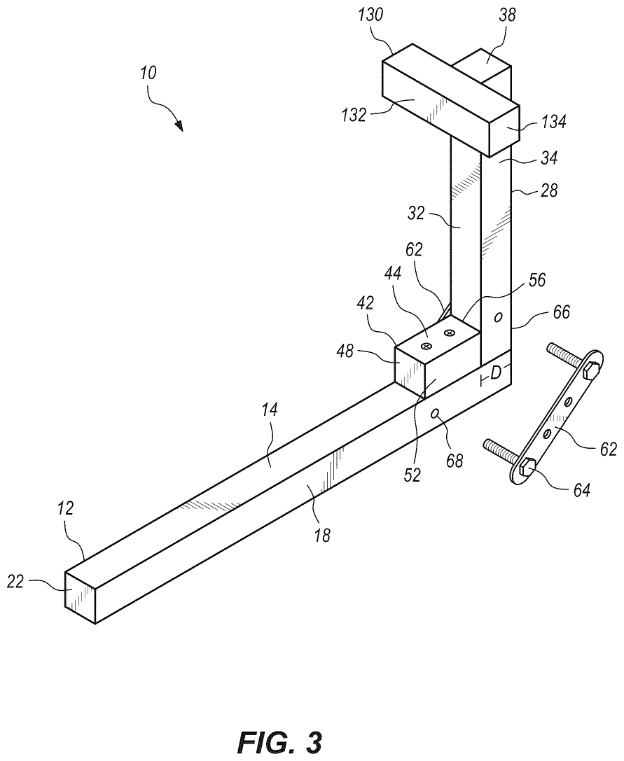

FIG. 3 is a side perspective view of the load bearing hinge joint of the present invention in an open or expanded configuration.

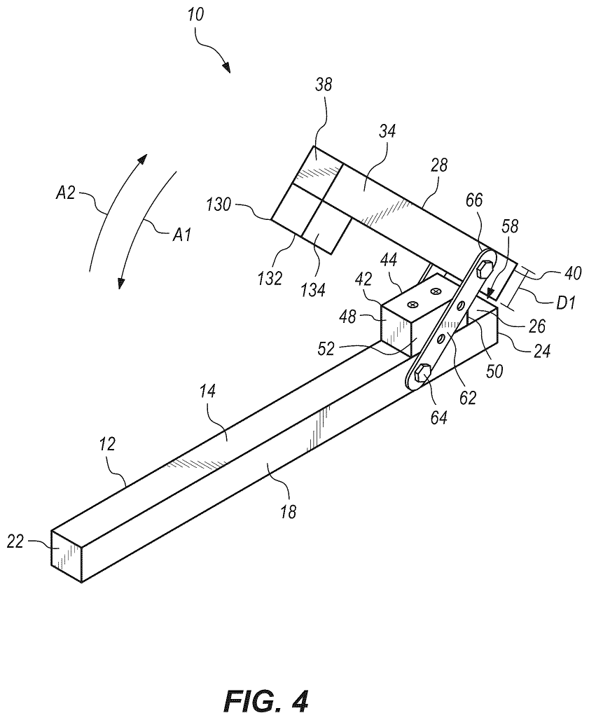

FIG. 4 is a perspective view of the load bearing hinge joint of the present invention as it transitions from a collapsed or folded to an open or expanded configuration and/or vice versa.

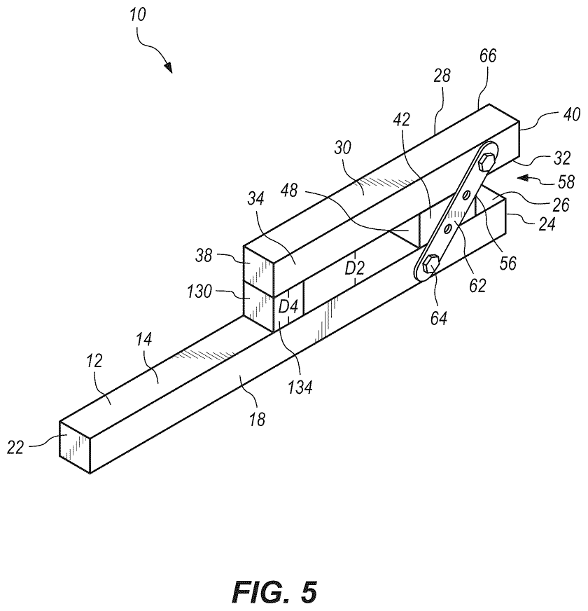

FIG. 5 is a front perspective side view of the load bearing hinge joint of the present invention in a fully collapsed configuration.

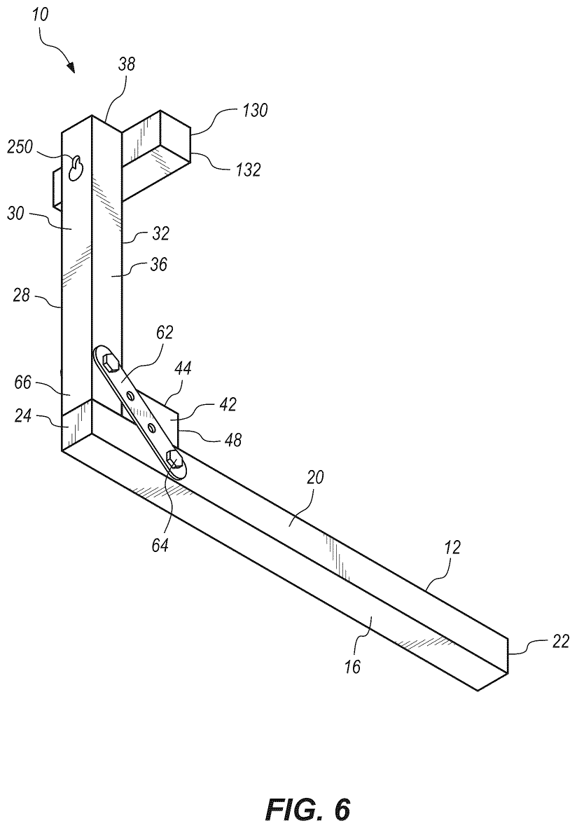

FIG. 6 is a rear side perspective view of the load bearing joint of the present invention in an open or expanded configuration.

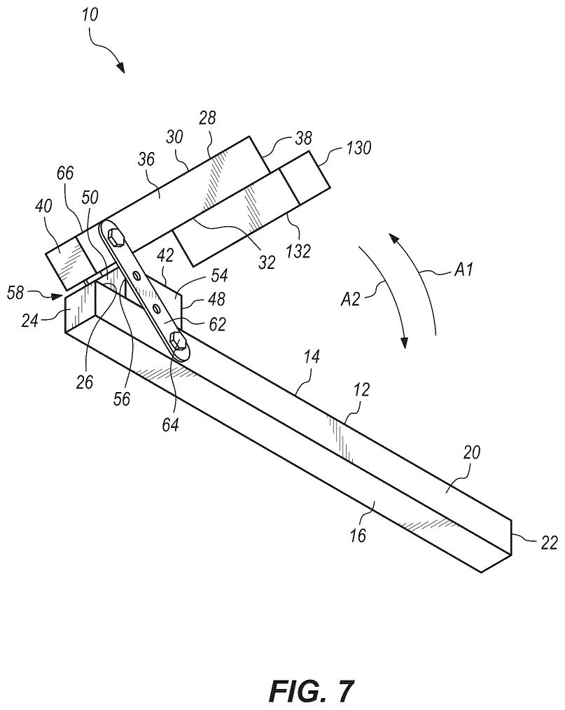

FIG. 7 is a rear side perspective view of the load bearing joint of the present invention as it transitions from a collapsed or folded to an open configuration and/or vice versa.

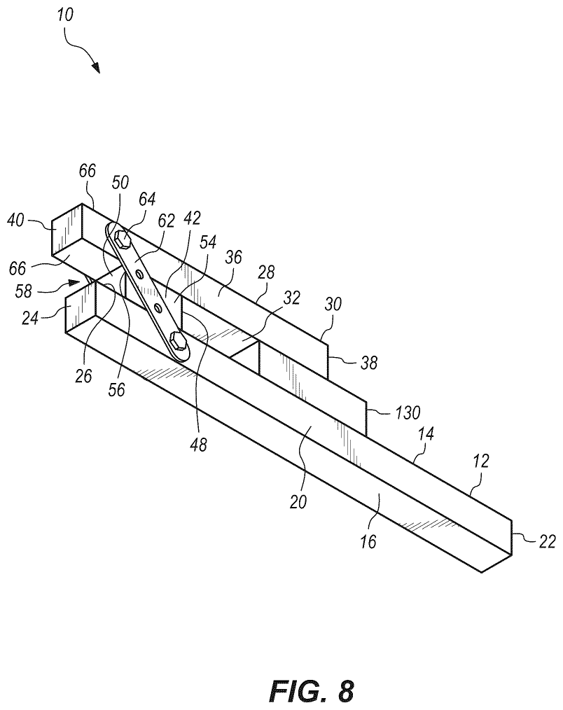

FIG. 8 is a rear side perspective view of the load bearing joint of the present invention in a closed configuration.

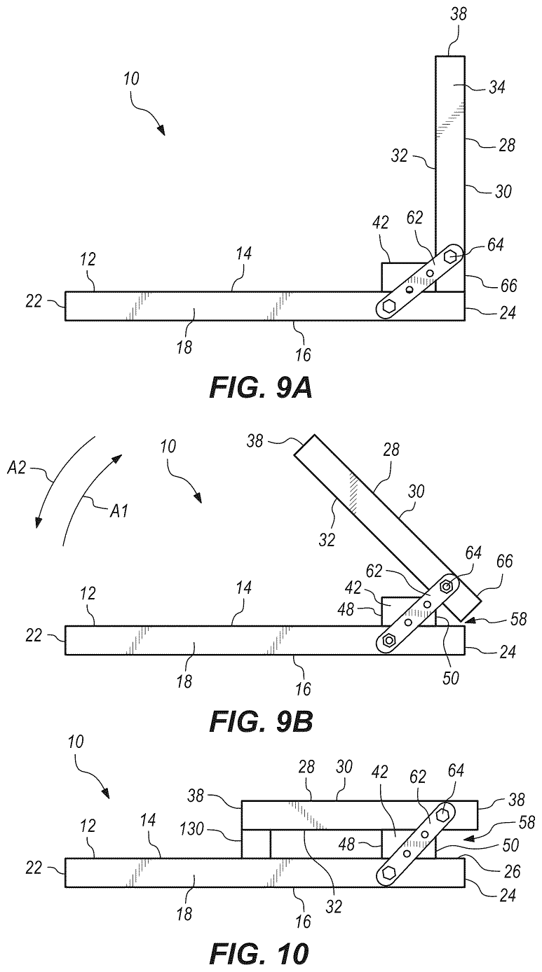

FIG. 9A is a side view of the load bearing hinge joint of the present invention in an open or expanded configuration.

FIG. 9B is another side view of the load bearing hinge joint of the present invention as it transitions from a collapsed or folded to an open or expanded configuration and/or vice versa.

FIG. 10 is a side view of the load bearing hinge joint of the present invention in a collapsed configuration.

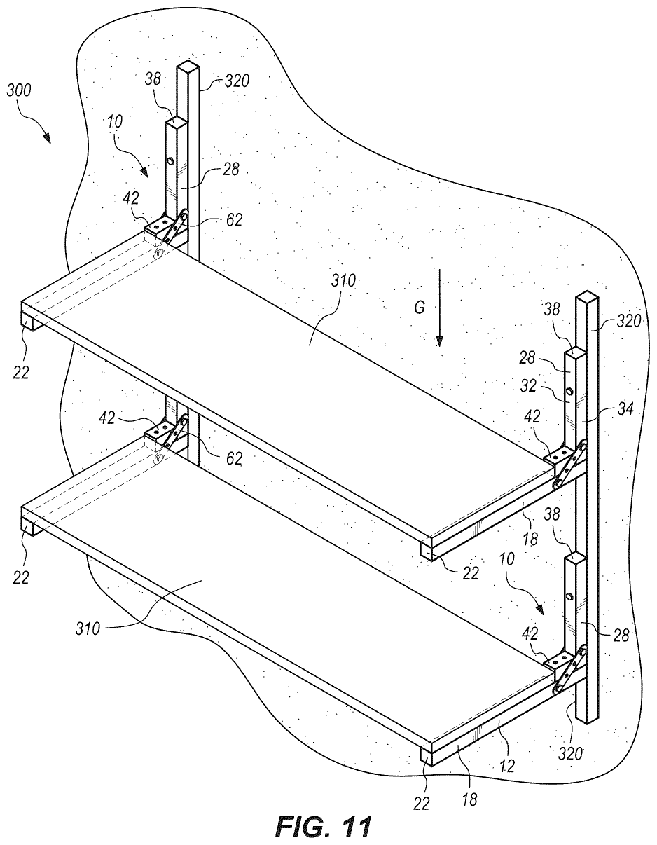

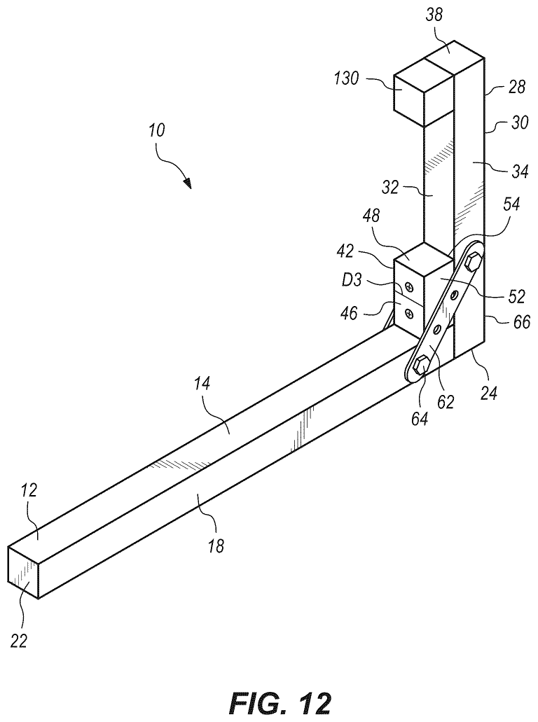

FIG. 11 is a side view of the load bearing hinge joint of the present invention in an open or expanded configuration incorporated in a shelving unit assembly.

FIG. 12 is another front perspective side view of the load bearing hinge joint of the present invention in an open or expanded configuration.

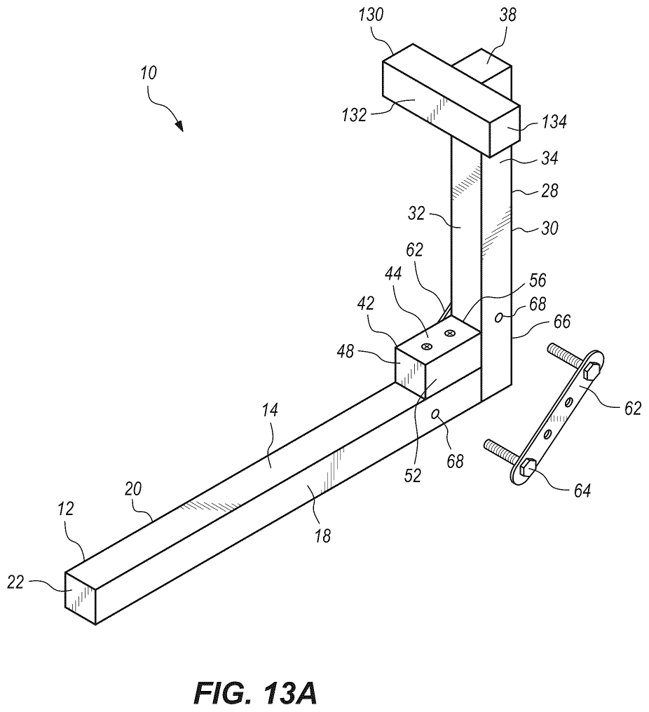

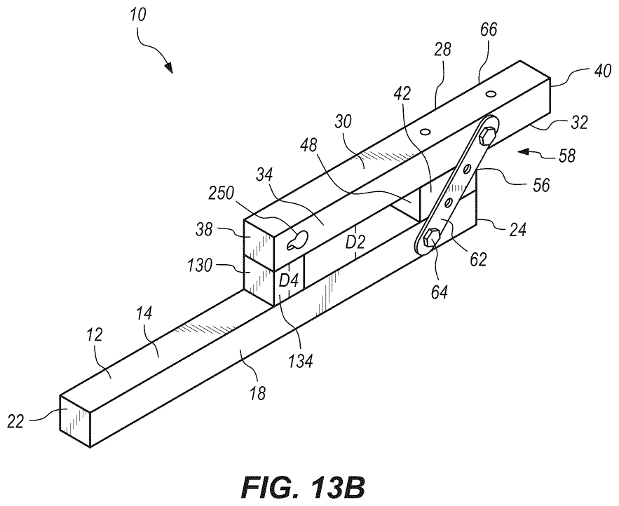

FIG. 13A is another front perspective side view of an embodiment of the load bearing hinge joint of the present invention in an open or expanded configuration.

FIG. 13B is a side perspective view of an embodiment of the load bearing hinge joint of the present invention in a collapsed configuration.

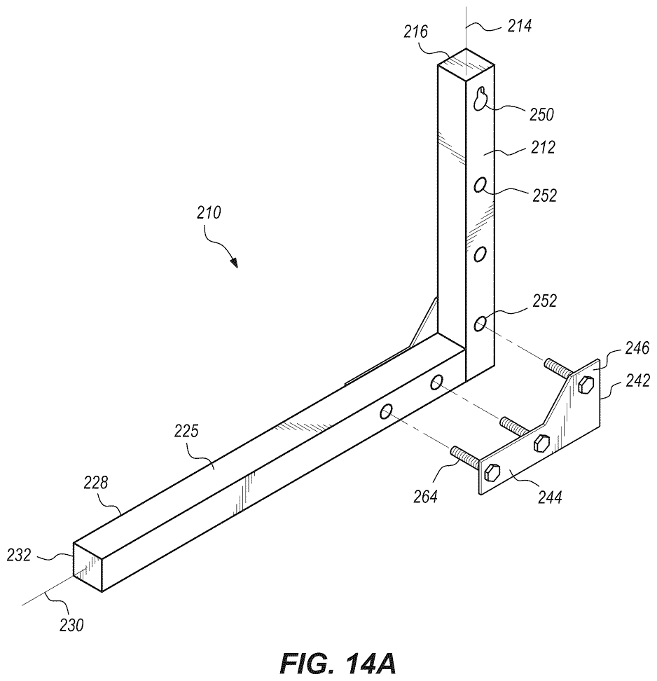

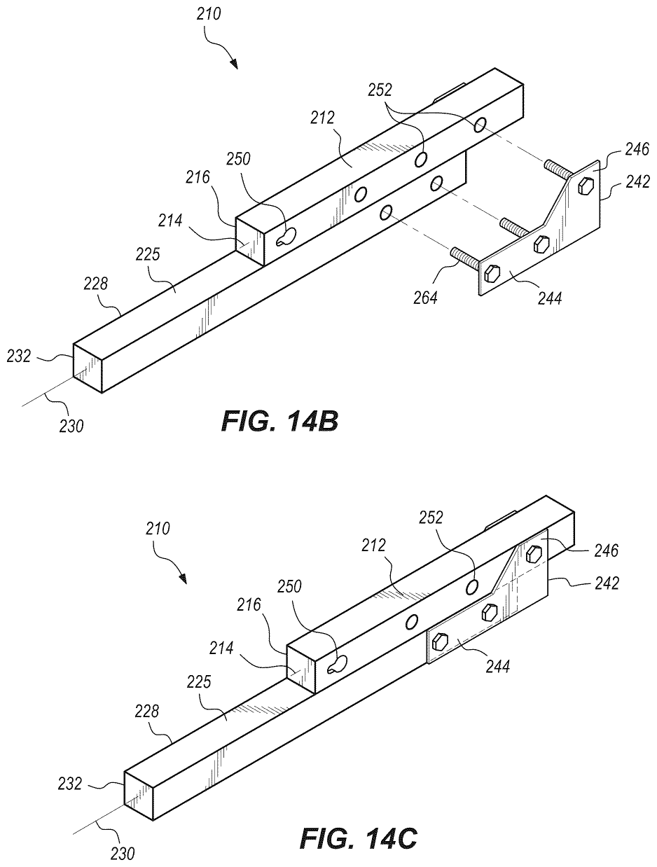

FIG. 14A is a side perspective view of an embodiment of the load bearing hinge joint of the present invention in an open configuration.

FIG. 14B is a side perspective view of an embodiment of the load bearing hinge joint of the present invention in a collapsed configuration.

FIG. 14C is a side perspective view of an embodiment of the load bearing hinge joint of the present invention in a collapsed configuration.

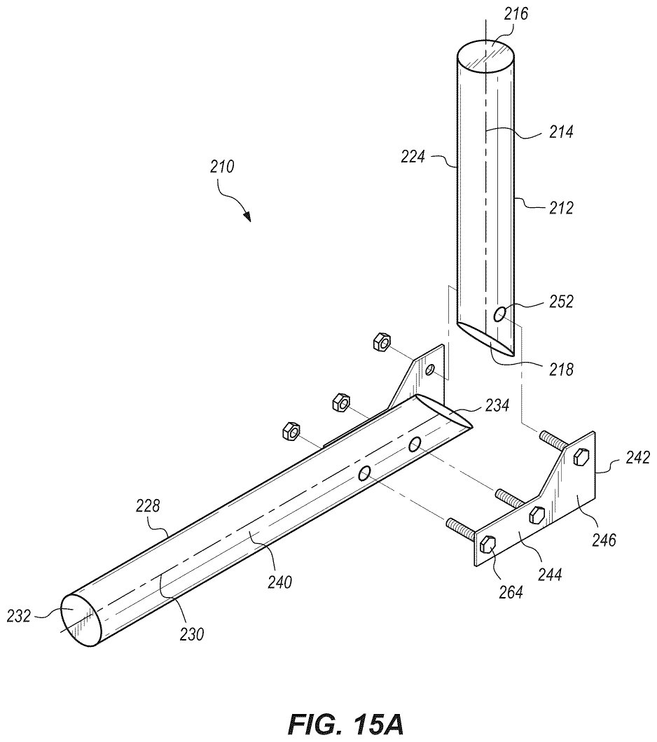

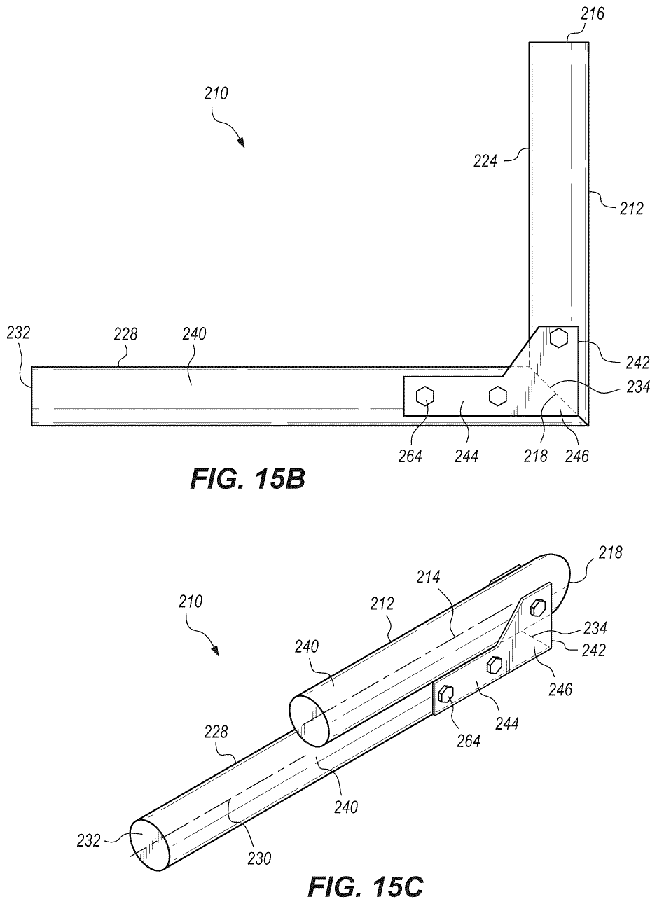

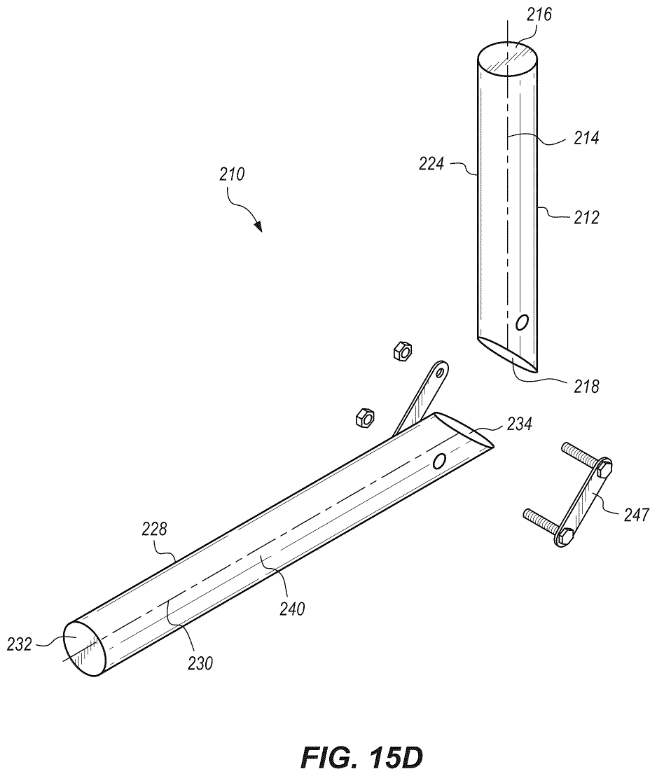

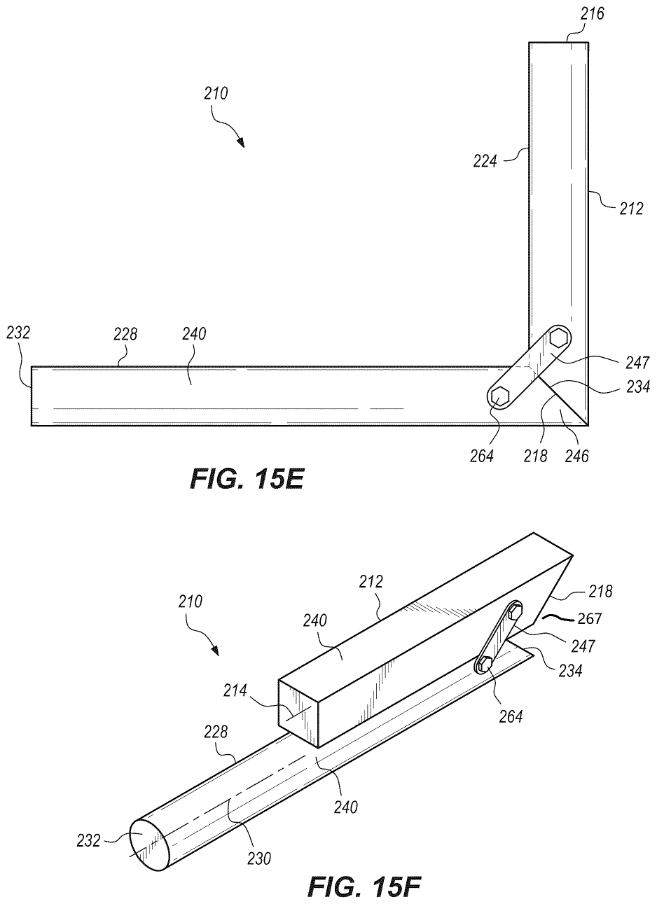

FIG. 15A is an exploded side perspective view of an embodiment of the load bearing hinge joint of the present invention in an open configuration.

FIG. 15B is a side plan view of an embodiment of the load bearing hinge joint of the present invention in a collapsed configuration.

FIG. 15C is a side perspective view of an embodiment of the load bearing hinge joint of the present invention in a collapsed configuration.

FIG. 15D is an exploded side perspective view of an embodiment of the load bearing hinge joint of the present invention in an open configuration.

FIG. 15E is a side plan view of an embodiment of the load bearing hinge joint of the present invention in a collapsed configuration.

FIG. 15F is a side perspective view of an embodiment of the load bearing hinge joint of the present invention in a collapsed configuration illustrating the combined use of a member having a substantially rectangular cross section and a cylindrical member having a circular cross-section.

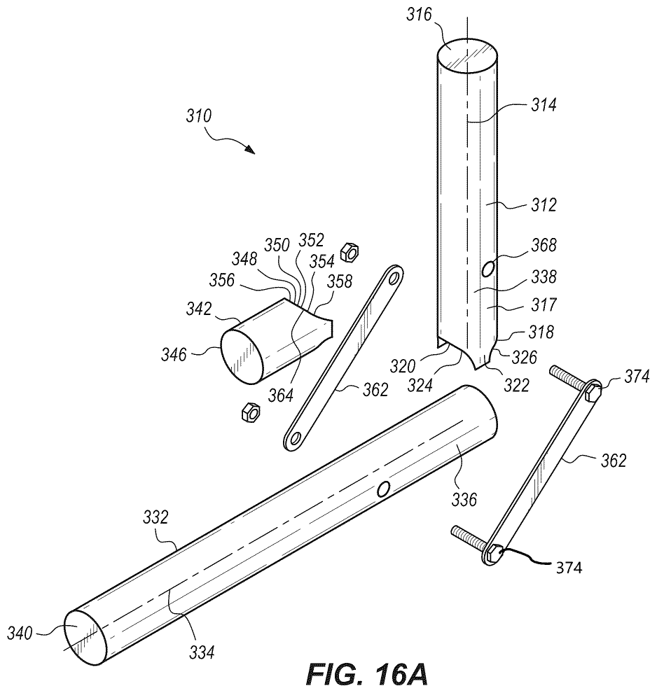

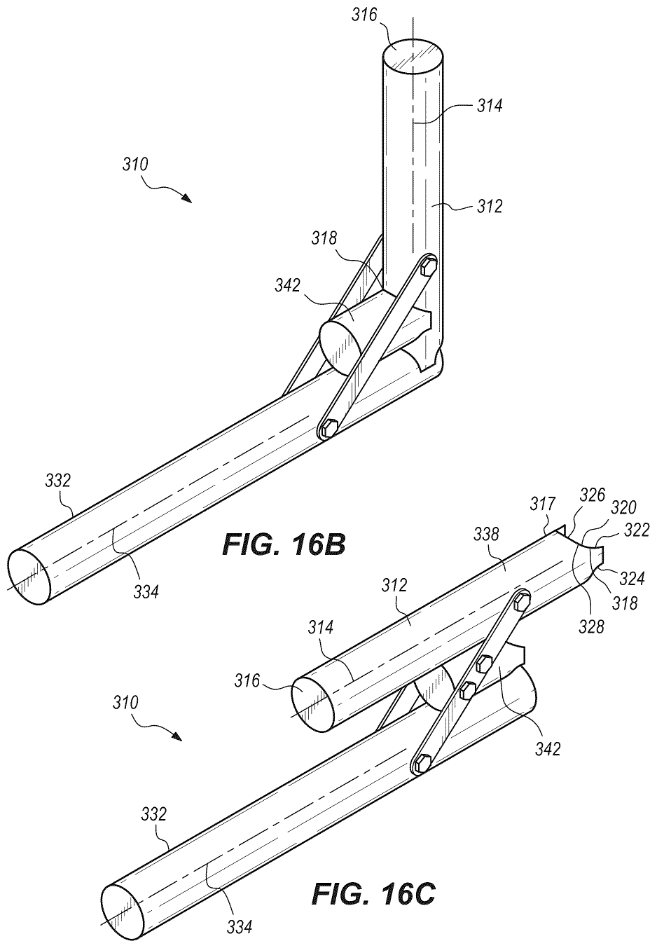

FIG. 16A is an exploded side perspective view of another embodiment of the load bearing hinge joint of the present invention in an open configuration.

FIG. 16B is a side perspective view of another embodiment of the load bearing hinge joint of the present invention in an open configuration.

FIG. 16C is a side perspective view of another embodiment of the load bearing hinge joint of the present invention in a collapsed configuration

### DETAILED DESCRIPTION OF THE PREFERRED EMBODIMENTS

Referring now to FIGS. 1-16C, there are shown illustrations of a load bearing hinge joint 10 of the invention. It is appreciated that the load bearing hinge joint 10 of the invention may be used in a variety of structures, wherein the structure may be collapsed or folded for storage purposes and conversely may be manipulated to an expanded configuration when the said structure is in use for bearing a heavy load. Structures using the load bearing hinge may include for example, exercise pull-up devices, stairs, ladders, chairs, shelving units and the like.

The load bearing hinge joint 10 of the invention includes a first arm member 12, a second arm member 28, a shoulder 42 that acts as a fulcrum along a pivot point 56 and one or more fastening means 62. In an expanded configuration of the load bearing hinge 10, the first arm member 12 is at a 90° degree angle to the second arm member 28.

The first arm member 12 includes a top surface 14, a bottom surface 16, a first side surface 18, a second side surface 20, a first end 22 and a second end 24 and a support seat 26 positioned on the top surface 14 of the first arm member 12, whereby the support seat 26 is positioned proximate to the second end 24 and wherein the support seat 26 includes a length that extends a distance D, measured from the second end 24, of the first arm member 12 to a second end 50 of the shoulder 42. The support seat 26 provides a platform to support the second end 24 of the first arm member 12 when a downward force G pushes the first arm member 12 against the support seat 26, such as for example when a downward force G is exerted on the second arm member 28 and/or a bar 100 as shown for example in FIGS. 1, 2 and 12.

The second arm member 28, includes a top surface 30, and a bottom surface 32, a first side surface 34, a second side surface 36, a first end 38 and a second end 40 of the second arm member 28. The first arm member 12 and the second arm member 28 are pivotally connected using one or more fastening means 62. The fastening means 62 include for example a mending brace 62 which connects the first arm member 12 to the second arm member 28 using a bolt 64 and nut attachment.

In a preferred embodiment, one or more apertures 68 are positioned on the first side surface 18 of the first arm member 12 and the first side surface 34 of the second arm member 28. In one embodiment, a plurality of apertures 68 are positioned along the top surface 14, the bottom surface 16, the first side surface 18 and the second side surface 20 of the first arm member 12. In one embodiment, a plurality of apertures 68 are positioned along the top surface 30, the bottom surface 32, the first side surface 34 and the second side surface 36 of the second arm member 28. Preferably, the bolts 64 pass through one or more of the plurality of apertures 68 to affix the mending braces 62 that connect the first arm member 12 to the second arm member 28. In a preferred embodiment, the plurality of apertures 68 of the first side surface 18 of the first arm member 12 and the second side surface 36 of the second arm member 28 are complimentarily aligned. It is appreciated that a plurality of mending braces 62 or other fastening means may be used thereby increasing the weight tolerance of the load bearing hinge joint 10 of the invention.

In a preferred embodiment, the shoulder 42 is positioned on a top surface 14 of the first arm member 12. A second end 50 of the shoulder 42 is positioned at a distance D from the second end 24 of the first arm member 12. In a preferred embodiment, the second end 40 of the second arm member 28, includes a length D1, wherein D1 is equal to D, the length of the support seat, measured from the second end 24 of the first arm member 12 to the second end 50 of the shoulder 42. In another embodiment, D1 is less than D. In one embodiment, the first arm member 12 and the shoulder 42 form a single unitary structure.

In another embodiment, the shoulder 42 may be separately affixed to the first arm member 12. The shoulder 42 includes a first side 52, a second side 54, a first end 48, the second end 50, a top surface 44 and may include a bottom surface 46 when the shoulder 42 is separately affixed to the first arm member 12. In one embodiment, the top surface 44 and the second end 50 of the shoulder 42 form a beveled surface 70.

In an expanded or open configuration, the second end 40 of the second arm member 28 rests on the support seat 26 on the top surface 14 of the first arm member 12. Preferably, the second end 40 of the second arm member 28 has a diameter or a length D1 wherein D1 is the same as the length, D of the support seat 26. In a preferred embodiment D1 is less than or equal to D.

In a collapsed or closed configuration, the bottom surface 32 of the second arm 28 is parallel to the top surface 14 of the first arm 12 and at a distance D2 from the first arm 12. In the collapsed configuration, the bottom surface 32 of the second arm 28 rests on the top surface 44 of the shoulder 42.

It is appreciated that handle 130 may comprise any suitable geometric shape for a particular application without departing from the scope of the invention. For example, and not by way of limitation, the handle 130 is shown as a rectangle in FIGS. 1, 3, 6, 7, 8. A rectangular shape may provide additional surface area for pressure distribution and add stability in certain applications, as shown for example in FIGS. 1, 2, 3, 7 and 8.

The handle 130 is rotatable and may be rotated 360 degrees in any direction relative to the second arm member 28. As shown for example in FIGS. 1, 2, 3, 6, 12 the handle 130 is rotated to a first position when the load bearing hinge joint 10 is in an expanded configuration. Conversely, as shown for example in FIGS. 5, 8, 10, the handle 130 may be rotated to a second position when the load bearing hinge joint 10 is in a collapsed configuration.

In a preferred embodiment, the handle 130 is removably affixed to the second arm member 28 and may be positioned along the bottom surface 32 of the second arm member 28. Preferably the handle 130 is positioned anywhere from a midpoint of the bottom surface 32 to a first end 38 of the second arm member 28. In one embodiment, the bottom surface 32 includes a plurality of holes (not shown) for attaching the handle 130 along various positions on the bottom surface 32. It is appreciated that both the first arm member 12 and second arm member 28 may include a plurality of holes (not shown) for attaching the handle 130, mending brace 62 or bar 100.

Referring now in particular to FIG. 1 there is shown a front perspective side view of the load bearing hinge joint 10 of the present invention affixed to the bar 100 and handle 130 in an exercise pull-up device 140. There is shown the first arm member 12 including the top surface 14 of the first arm member 12, the bottom surface 16 of the first arm member 12, the first side surface 18 of the first arm member 12, the first end 22 and the second end 24 of the first arm member 12.

The second end 40 of the second arm member 28 is positioned at a substantially right angle to the first arm member 12 and proximate to the support seat 26 of the first arm member 12. The second end 24 of the first arm member 12 is positioned distal to the first end 22 of the first arm member 12. As shown, the bar 100 is affixed to the first arm members 12 using a bolt 64 and nut combination. Preferably the bar 100 is foldable at a midpoint 120 and has a length L, wherein L is substantially equal to the width of a typical doorway opening. In a preferred embodiment, the bar 100 includes end covers 110 positioned over a first end 102 of the bar 100 and a second end 104 of the bar 100. Preferably, the end covers 110 are formed of a rubber material for securing the bar 100 within the door frame.

The handle or grip 130 is affixed to a portion of the second arm member 28. In a preferred embodiment, the handle 130 is proximate to the first end 38 of the second arm member 28 for attaching to a support structure. In a preferred embodiment, the support structure is a door frame 200 when the pull-up device 140 is in use. In one embodiment a single handle 130 is affixed to two or more load bearing hinge joints 10. In another embodiment, each hinge joint 10 includes a separate handle 130.

There is shown the second arm member 28, including the top surface 30 of the second arm member 28, the bottom surface 32 of the second arm member 28, the first side surface 34 of the second arm member 28. The second end 40 of the second arm member 28 is positioned atop the support seat 26 of the first arm member 12. The first end 38 of the second arm member 28 is distal to the second end 40 of the second arm member 28. There is shown a plurality of spaced apertures 68 positioned on the first arm member 12 and the second arm member 28 for receiving fastening means, such as the mending brace 62 secured using a nut and bolt 64 attachment and for affixing the bar 100 to the first arm members 12.

The first arm member 12 includes the shoulder 42 which is positioned on the top surface 14 of the first arm member 12 and proximate to the second end 24 of the first arm member 12 and at a distance D from the second end 24 of the first arm member 12, wherein the length of the support seat 26 of the first arm member 12 is shown as D, wherein D is measured from the second end 24 of the first arm member 12 to the second end 50 of the shoulder 42. In a preferred embodiment the first arm member 12 and the shoulder 42, comprise a single unitary member. In another embodiment the shoulder 42 is fixedly secured and affixed to the first arm member 12. There is shown the pivot point 56 of the shoulder 42, the second end 50 of the shoulder 42 aligns with, and abuts to, a lower portion of the bottom surface 32 of the second arm member 28.

One or more mending braces 62 secure the first arm member 12 to the second arm member 28. In a preferred embodiment, the mending braces 62 traverse across the first side 52 of the shoulder 42 and the second side 54 of the shoulder 42 to secure the first arm member 12 to the second arm member 28. The mending braces 62 are secured to the first arm member 12 using a bolt 64 and nut (not shown) combination. The bolt 64 passes through the aperture 68 located on the first side 18 of the first arm member 12 through to the second side 20 of the first arm member 12 and is secured using the bolt 64 and nut (not shown). The mending brace 62 is similarly secured to the second arm member 28 using the bolt 64 and nut (not shown) connection. The bolt 64 passes through the aperture 68 located on the first side 34 of the second arm member 28 to the second side 36 of the second arm member 28 and is secured and the second arm member 12 using the bolt 64 and nut (not shown).

In one embodiment, a plurality of mending braces 62 are used to secure the first arm member 12 to the second arm member 28 to ensure a stronger connection between the first arm member 12 and the second arm member 28. The plurality of mending braces 62 secure the first arm member 12 to the second arm member 28 using for example connection means such as bolts 64 and nuts (not shown), wherein the bolts 64 pass through the apertures 68 and are secured using nuts (not shown).

Referring now in particular to FIG. 2 there is shown a side view of the load bearing hinge joint 10 incorporated in an exercise pull-up device 140 as shown in FIG. 1 for use in conjunction with a door-frame 200. As shown, the handle or grip 130 is configured to sit atop the door frame 200 when the pull-up device 140 is in use.

Referring now in particular to FIG. 3 there is shown a side perspective view of the load bearing hinge joint 10 of the present invention in an open configuration. The first arm member 12, includes the first end 22, the second end 24, the top surface 14, the bottom surface 16 (shown in FIGS. 6, 7, 8), the first side surface 18 and the second side surface 20 (shown in FIGS. 6, 7, 8). The support seat 26 (shown in FIGS. 4, 5) of the first arm member 12 includes a length D, wherein D is the distance measured from the second end 24 of the first arm 12 to the second end 50 of the shoulder 42.

The shoulder 42 of the first arm member 12 includes the top surface 44, the bottom surface 46 (shown in FIG. 12), the first end 48, the second end 50, the first side 52 and the second side 54 (shown in FIGS. 6, 7, 8). In this embodiment, the shoulder 42 and the first arm member 12 comprise a single unitary body.

The second arm member 28, includes the top surface 30 (shown in FIGS. 5, 6, 7,8), the bottom surface 32, the first side 34, the second side 36 (not shown), first end 38, the second end 40 (shown in FIGS. 7, 8, 10) whereby the second end 40 is supported by and sits atop the support seat 26. The second end 40 includes a length D1, wherein D1 is less than or equal to D. In a preferred embodiment, illustrated in FIG. 3, D1 is equal to D. A bottom portion 66 of the second arm member 28 positioned on the bottom surface 32 and proximate to the second end 40 abuts the second 50 of the shoulder 42.

Mending braces 62 connect the first arm member 12 to the second arm member 28. Apertures 68 along the first arm member 12 and second arm member 28 are positioned for receiving bolts 64 to secure the first arm member 12 to the second arm member 28 thereby allowing the second arm member 28 to pivot about the shoulder 42 of the first arm member 12 about pivot point 56. The shoulder 42 acts as a fulcrum to enable engagement between the first arm member 12 and the second arm member 28 to transition from an open or expanded configuration to a closed or expanded configuration. In a preferred embodiment, the mending braces 62 traverse the first side 52 of the shoulder 42 and the second side 54 of the shoulder 42 of the first arm member 12 member 12.

Referring now in particular to FIG. 4 is a perspective view of the load bearing hinge joint 10 of the present invention as it transitions from a collapsed or folded configuration as illustrated by arrow A1 to an open or expanded configuration as illustrated by arrow A2. In this embodiment, the shoulder 42 is affixed to the first arm member 12. The fastening means 62 which secure the first arm member 12 to the second arm member 28 allow for a rotation of movement to transition the load bearing hinge joint 10 from a collapsed configuration to an open configuration and vice versa. As shown, the handle or grip 130 is affixed to the second arm member 28. In a preferred embodiment, the handle 130 is positioned on a bottom surface 32 of the second arm member 28 proximate to the first end 38 and distal to the second end 40 of the second arm member 28. In one embodiment, the handle 130 and the second arm member 12 comprise a unitary body. In another embodiment, the handle 130 is affixed to the second arm member 12.

Referring to arrow A2, there is shown the second arm member 28 as it transitions from a position of rest on the shoulder 42 and pivots about the pivot point 56 which acts as a fulcrum. A clearance area 58 formed between the support seat 26 and second end 50 of the shoulder 42 is dimensioned to receive the bottom portion 66 of the second arm member 28 and to allow the bottom portion 66 of the second arm member 28 to swivel about the pivot point 56 and slide into the clearance area 58 as the second end 40 of the second arm member 28 comes to rests on the support seat 26 of the first arm member 12 when the load bearing joint 10 is in an open configuration and the second arm member 28 is at a right angle to the first arm member 12.

In one embodiment, the clearance area 58 is greater than or equal to the area of the bottom portion 66 of the second arm member 12. In a preferred embodiment, the clearance area is equal to the area of the bottom portion 66 of the second arm member, thereby allowing the bottom portion 66 of the second arm member 28 to occupy the clearance area 58. In another embodiment, the bottom portion 66 of the second arm member 28 occupies an area smaller in size than the clearance area 58.

Referring to arrow A1, there is shown the second arm member 28 as it transitions from an open configuration to a collapsed or folded configuration. In this scenario, as the bottom portion 66 of the second arm member 28 rotates about the pivot point 56, the second end 40 of the second arm member 28 lifts from its position on the support seat 26. In a collapsed configuration, the bottom surface of 32 of the second arm member 28 is parallel to the top surface 14 of the first arm member 12 and at a distance D2 from the first arm member 12. In this collapsed configuration, a portion of the bottom surface 32 of the second arm member 28 rests on a portion of the top surface 44 of the shoulder 42.

Referring now in particular to FIG. 5 is a front perspective side view of the load bearing hinge joint 10 of the present invention in a fully collapsed configuration. In this configuration, the second arm member 28 is parallel to the first arm member 12 and at a distance D2 from the first arm member 12. In this collapsed configuration, at least a portion of the bottom surface 32 of the second arm member 28 rests on the top surface 44 of the shoulder 42. At least one of the mending braces 62 traverse across the first side 52 and second side 54 (shown in FIG. 8) of the shoulder 42 and connects the first arm member 12 to the second arm member 28. The first side 52 of shoulder 42 is opposite facing to, and at a distance D3, from the second side 54 of the shoulder 42. In a preferred embodiment, D3 is also the distance from the first side surface 18 of the first arm 12 to the second side surface 20 of the first arm 12.

In this configuration, the bottom portion 66 of the second arm member 28, including the second end 40 of the second arm 28 extend beyond the second end 24 of the first arm 12 and outside clearance area 58.

A front surface 132 of the handle 130 contacts and sits on the top surface 14 of the first arm member 12, when the load bearing hinge joint 10 is in a collapsed or closed configuration. In a preferred embodiment, a first side surface 134 of the handle 130 has a width D4, whereby D4 is the same as D2, the distance between the bottom surface 32 of the second arm member 28 and the top surface 14 of the first arm member 12 when the load bearing hinge joint 10 is in a closed or collapsed configuration.

Referring now in particular to FIG. 6 there is shown a rear side perspective view of the load bearing joint 10 of the present invention in an open or expanded configuration. The first arm member 12, includes the first end 22, the second end 24, the top surface 14 (shown in FIGS. 3, 4, 5), the bottom surface 16, the first side surface 18 (shown in FIGS. 3, 4, 5) and the second side surface 20. The support seat 26 (shown in FIGS. 4, 5) of the first arm member 12 includes a length D, wherein D is the distance measured from the second end 24 of the first arm 12 to the second end 50 of the shoulder 42 (shown in FIGS. 4,5).

The shoulder 42 of the first arm member 12 includes the top surface 44 (shown in FIGS. 3, 4), the bottom surface 46 (shown in FIG. 12), the first end 48, the second end 50 (shown in FIGS. 4, 5), the first side 52 (shown in FIGS. 3, 4, 5) and the second side 54.

The second arm member 28, includes the top surface 30, the bottom surface 32, (shown in FIGS. 3, 4) the first side 34 (shown in FIGS. 3, 4, 5), the second side 36, first end 38, the second end 40 (shown in FIGS. 7, 8, 10) whereby the second end 40 is supported by and sits atop the support seat 26. The second end 40 includes a length D1, wherein D1 is less than or equal to D. A bottom portion 66 of the second arm member 28 positioned on the bottom surface 32 and proximate to the second end 40 abuts the second 50 of the shoulder 42.

Mending braces 62 connect the first arm member 12 to the second arm member 28. Apertures 68 along the first arm member 12 and second arm member 28 are positioned for receiving bolts 64 to secure the first arm member 12 to the second arm member 28 thereby allowing the second arm member 28 to pivot about the shoulder 42 of the first arm member 12 about pivot point 56. In a preferred embodiment, the mending braces 62 traverse the first side 52 of the shoulder 42 and the second side 54 of the shoulder 42 of the first arm member 12 member 12.

Referring now in particular to FIG. 7 there is shown a rear side perspective view of the load bearing joint of the present invention as it transitions from a collapsed or folded configuration as illustrated by arrow A1 to an open or expanded configuration as illustrated by arrow A2. The fastening means 62 which secure the first arm member 12 to the second arm member 28 allow for a rotation of movement to transition the load bearing hinge joint 10 from a collapsed configuration to an open configuration and vice versa. As shown, the handle 130 is affixed to the second arm member 28. In a preferred embodiment, the handle 130 is positioned on a bottom surface 32 of the second arm member 28 proximate to the first end 38 and distal to the second end 40 of the second arm member 28. In one embodiment, the handle 130 and the second arm member 12 comprise a unitary body. In another embodiment, the handle 130 is affixed to the second arm member 12.

Referring to arrow A2, there is shown the second arm member 28 as it transitions from a position of rest on the shoulder 42 and pivots about the pivot point 56 of the shoulder 42 which acts as a fulcrum. A clearance area 58 formed between the support seat 26 and second end 50 of the shoulder 42 is dimensioned to receive the bottom portion 66 of the second arm member 28 and to allow the bottom portion 66 of the second arm member 28 to swivel about the pivot point 56 and slide into the clearance area 58 as the second end 40 of the second arm member 28 comes to rests on the support seat 26 of the first arm member 12 when the load bearing joint 10 is in an open configuration and the second arm member 28 is at a right angle to the first arm member 12.

In one embodiment, the clearance area 58 is greater than or equal to the area of the bottom portion 66 of the second arm member 12. In a preferred embodiment, the clearance area is equal to the area of the bottom portion 66 of the second arm member, thereby allowing the bottom portion 66 of the second arm member 28 to occupy the clearance area 58. In another embodiment, the bottom portion 66 of the second arm member 28 occupies an area smaller in size than the clearance area 58.

Referring to arrow A1, there is shown the second arm member 28 as it transitions from an open configuration to a collapsed or folded configuration. In this scenario, as the bottom portion 66 of the second arm member 28 rotates about the pivot point 56, the second end 40 of the second arm member 28 lifts from its position on the support seat 26. In a collapsed configuration, the bottom surface of 32 of the second arm member 28 is parallel to the top surface 14 of the first arm member 12 and at a distance D2 from the first arm member 12. In this collapsed configuration, a portion of the bottom surface 32 of the second arm member 28 rests on a portion of the top surface 44 of the shoulder 42.

Referring now in particular to FIG. 8 there is shown a rear side perspective view of the load bearing joint 10 of the present invention in a closed configuration. The second arm member 28 is parallel to the first arm member 12 and a distance D2 from the first arm member 12. In this collapsed configuration, at least a portion of the bottom surface 32 of the second arm member 28 rests on the top surface 44 (shown in FIGS. 2, 3) of the shoulder 42. At least one of the mending braces 62 traverse across each of the first side 52 (shown in FIG. 5) and second side 54 of the shoulder 42 and connect the first arm member 12 to the second arm member 28. The first side 52 (shown in FIG. 5) of shoulder 42 is opposite facing to, and at a distance D3, from the second side 54 of the shoulder 42.

In this configuration, the bottom portion 66 of the second arm member 28, including the second end 40 of the second arm 28 extend beyond the second end 24 of the first arm 12 and beyond clearance area 58.

A front surface 132 (shown in FIG. 3) of the handle 130 contacts and sits on the top surface 14 (shown in FIGS. 3, 4, 5) of the first arm member 12, when the load bearing hinge joint 10 is in a collapsed or closed configuration. In one embodiment, a first side surface 134 (shown in FIGS. 3, 4) of the handle 130 has a width D4, whereby D4 is the same as D2, the distance between the bottom surface 32 of the second arm member 28 and the top surface 14 (shown in FIGS. 3, 4) of the first arm member 12 when the load bearing hinge joint 10 is in a closed or collapsed configuration.

Referring now in particular to FIG. 9 there is shown a side view of another embodiment of the load bearing hinge joint 10 of the present invention in an open or expanded configuration.

Referring now in particular to FIG. 9A this is shown another side view of the load bearing hinge joint 10 of the present invention as it transitions from a collapsed or folded configuration as illustrated by arrow A1 to an open or expanded configuration as illustrated by arrow A2.

Referring now in particular to FIG. 10 there is shown a side view of the load bearing hinge joint 10 of the present invention in a collapsed configuration. In this configuration, the second arm member 28 is parallel to the first arm member 12 and at a distance D2 from the first arm member 12. In this collapsed configuration, at least a portion of the bottom surface 32 of the second arm member 28 rests on the top surface 44 of the shoulder 42. At least one of the mending braces 62 traverse across the first side 52 and second side 54 (shown in FIG. 8) of the shoulder 42 and connects the first arm member 12 to the second arm member 28. The first side 52 of shoulder 42 is opposite facing to, and at a distance D3, from the second side 54 of the shoulder 42.

In this configuration, the bottom portion 66 of the second arm member 28, including the second end 40 of the second arm 28 extend beyond the second end 24 of the first arm 12 and outside clearance area 58.

A front surface 132 (shown in FIG. 3) of the handle 130 contacts and sits on the top surface 14 of the first arm member 12, when the load bearing hinge joint 10 is in a collapsed or closed configuration. In a preferred embodiment, a first side surface 134 of the handle 130 has a width D4, whereby D4 is the same as D2, the distance between the bottom surface 32 of the second arm member 28 and the top surface 14 of the first arm member 12 when the load bearing hinge joint 10 is in a closed or collapsed configuration.

Referring now in particular to FIG. 11 there is shown a perspective side view of the load bearing hinge joint 10 of the present invention in an open or expanded configuration incorporated in a shelving unit assembly 300. The load bearing hinge joint 10 is affixed to a support frame 320, a shelf 310 is affixed to the top surface 14 of the first arm member 12. In one embodiment, a plurality of load bearing hinge joints 10 may be used to support each shelf.

Referring now in particular to FIG. 12 there is shown another front perspective side view of the load bearing hinge joint 10 the present invention in an open or expanded configuration.

Referring now in particular to FIGS. 13A-13B there is shown the load bearing hinge joint 10 including the first arm member 12, wherein the first arm member 12 includes the top surface 14, the bottom surface 16, the first side surface 18, the second side surface 20, the first end 22 and the second end 24 of the first arm member 12; wherein the first side surface 18 of the first arm member 12 is opposite to, and at a distance from, the second side surface 20 of the first arm member 12.

As shown, the load bearing hinge 10 further includes the second arm member 28; the second arm member 28 includes the top surface 30, the bottom surface 32, the first side surface 34, the second side surface 36 (not shown), the first end 38 and the second end 40 of the second arm member 28; the first side surface 34 of the second arm member 28 is opposite to, and at a second distance from, the second side surface 36 (shown in FIG. 8) of the second arm member 28.

There is shown the fastening means 62 for pivotally interconnecting the second arm member 28 to the first arm member 12. In an embodiment, the fastening means 62 is positioned on the first side surface 18 of the first arm member 12, extends across at least a portion of the first side surface 52 of the shoulder block 42 and connects the first arm member 12 to the second arm member 28 at the first side surface 34 of the second arm member 28. It is appreciated that a second fastening means 62 may also be positioned on the second side surface 20 of the first arm member 12 to connect the first arm member 12 to the second arm member 28 at the second side surface 36 of the second arm member 28. The bolt and nut 64 connection may be used to affix the fastening means 62 to the block 42, the first arm member 12 and second arm member 28. In one embodiment, the block 42 may be integrally connected with the first arm member 12, or the second arm member 28. Alternatively, the block 42, fastening means 62 and the first arm member 12, or the second arm member 28 may be welded together. The block 42 and the first arm member 12, or the block 42 and the second arm member 28 may form a unitary structure. The fastening means 62 may also secure the block 42 using bolts 64.

In a preferred embodiment, as shown, the shoulder 42 includes the first end 48, the second end 50, and the shoulder 42 is positioned on the top surface 30 of the first arm member 12 and wherein the second end 50 of the shoulder 42 is positioned at or near the second end 24 of the first arm member 12 and is configured to act as a fulcrum to facilitate a pivotal rotation of the second arm member 28 relative to the first arm member 12 at the pivot point 56.

In a preferred embodiment, the load bearing hinge joint 10, including the first arm member 12, the second arm member 28 and the shoulder 42 comprise a single unitary body. In another embodiment, the load bearing hinge joint 10, including the first arm member 12 and the shoulder 42 comprise a single unitary body. In yet another embodiment, the load bearing hinge joint 10, including the second arm member 28 and the shoulder 42 comprise a single unitary body. As shown, the fastening means 62 for pivotally connecting the first arm member 12 to the second arm 28 traverses across a first side 52 of the shoulder 42.

The second end 50 of the shoulder 42 is positioned proximate to, the second end 24 of the first arm member 12 and is configured to act as a fulcrum to facilitate pivotal rotation of the second arm member 28 relative to the first arm member 12 at the pivot point 56.

Alternatively, the second end 50 of the shoulder 42 abuts the second end 24 of the first arm member 12 and is configured to act as a fulcrum to facilitate pivotal rotation of the second arm member 28 relative to the first arm member 12 at the pivot point 56.

Referring now in particular to FIGS. 14A-15C there is show a load bearing hinge joint 210 including a first elongated member 212 defining a longitudinal first axis 214. One or more keyhole attachments 250 (shown in FIGS. 13B, 14A-14C) are provided on a surface of the arm members 12, 28; 212, 228; 312, 332; and configured to permit the hinge joints 10, 210, 310, as well as an apparatus incorporating the load bearing hinge joint 10, 210, 310, such as an exercise pull-up device as shown in FIG. 1, to be hung on a wall or other support structure.

Referring to FIGS. 15A-15C in particular, the first elongated member 212 includes a first end 216 formed with a first planar joining surface 218 oriented at approximately a forty-five degree angle 220 relative to the first axis 214. A second elongated member 228 defining a longitudinal second axis 230 and having a first end portion 232 formed with a second planar joining surface 234 oriented at approximately a forty-five degree angle relative 236 to the second axis 230. As shown, in FIGS. 14A-14C, the first elongated member 212 and the second elongated member 228 include a rectangular cross section. FIGS. 15A-15C illustrate first elongated member 212 and the second elongated member 228 having a circular cross section.

The first planar joining surface 218 and the second planar joining surface 234 are positioned in abutting engagement when the hinge joint 210 is in an open configuration, such that the first axis 214 and the second axis 230 are oriented substantially perpendicular to one another.

As shown, the abutting planar joining surfaces 218, 234 mechanically couple the first elongated structural member 212 to the second elongated structural member 228 to resist relative to resist relative translation while permitting rotation about the hinge axis 248. The first elongated member 212 and the second elongated member 228 each have a tubular cross-section 224, 240. The planar joining surfaces 218, 234 of the load bearing hinge joint 210 are configured to define a shear load path for transmitting shear forces parallel to the plane of engagement.

The load bearing hinge joint 210 includes fastening means 242 for pivotally connecting the first elongated member 212 to the second elongated member 228. In a preferred embodiment, the fastening means 242 includes an L-shaped configuration having a first portion 244 affixed to the first elongated member 212 and a second portion 246 affixed to the second elongated member 228, for connecting the first elongated member 212 to the second elongated member 228.

Portions, 244, 246 of the fastening means 242 are affixed to the first and second elongated members (212, 228). The fastening means 242 may take the form of a mending brace affixed with bolts as shown for example in FIGS. 12, 13A, 13B. As will be appreciated by one reasonably skilled in the art, the fastening means 242 selected from welding, brazing, adhesive bonding, or mechanical fastening that restrains relative translation between the first planar joining surface 218 and the second planar joining surface 234 while allowing relative rotation therebetween.

In one embodiment, first planar joining surface 218 includes a projecting tongue 222 (not shown)and the second planar joining surface 234 includes a corresponding groove 234 (not shown) configured to interlock when the planar joining surfaces 218, 234 abut. In an alternative embodiment.

As shown, the load bearing hinge joint 210 is movable to a closed configuration in which the first and second elongated members 212, 228, are rotated relative to one another so that the first and second axes 214, 230 form an acute angle less than 90 degrees, and the planar joining surfaces 218, 234 are separated while the members 212, 228 remain mechanically coupled. The planar joining surfaces 218, 234 extend across a full cross-section 224, 240 of the respective elongated structural members 212, 228. In one embodiment, while the first elongated arm member 212 has a cylindrical (circular) cross-section, the second arm 228 has a rectangular or square cross-section. In an alternate configuration, the first arm 212 has a rectangular or square cross-section and the second arm 228 has a cylindrical (circular) cross-section. In either of these configurations, injection molding may be used to adapt the cylindrical (circular) cross-section to the rectangular (square) cross section at their connection interface.

Referring now in particular to FIG. 15D there is shown an exploded side perspective view of an embodiment of the load bearing hinge joint 210 of the present invention in an open configuration. FIG. 15E is a side plan view of an embodiment of the load bearing hinge joint 10 of the present invention in a collapsed configuration. FIG. 15F is a side perspective view of an embodiment of the load bearing hinge joint 10 of the present invention in a collapsed configuration illustrating the combined use of a member having a substantially rectangular cross section 225, 241 and a cylindrical member having a circular cross-section 224, 240. Injection molding may be used to adapt the cylindrical (circular) cross-section to the rectangular (square) cross section at their connection interface 267.

Referring now in particular to FIGS. 16A-16C a load bearing hinge joint 310 including a first elongated member 312 extending along a first axis 314 and a second elongated member 332 extending along a second axis 334 oriented at an angle relative to the first axis 314. An end portion 316 of the first elongated member 312 includes a saddle portion 318 defining a generally U-shaped recess 320. The saddle portion 318 includes a base wall 322 and two opposing side walls 324, 326 extending from the base wall 322 to define a generally U-shaped channel 328.

The second elongated member 332 is received within the U-shaped recess 320 such that the saddle portion 318 at least partially surrounds a first portion 336 of the second elongated member 332 and connects the first elongated member 312 to the second elongated member 332.

As shown, the load bearing hinge joint 310, further includes a shoulder 342, wherein the shoulder 342 includes a first end 346 and a second end 348. The shoulder 342 is positioned on a top surface 330 of the first elongated member 312. The second end 348 of the shoulder 342 is positioned at or near a second end of the first elongated member 317 and is configured to act as a fulcrum to facilitate a pivotal rotation of the second elongated member 332 relative to the first elongated member 312 at a pivot point 364.

As shown the second end 348 of the shoulder 342 includes a saddle portion 350 defining a generally U-shaped recess 352, and including a base wall 354 and two opposing side walls 356, 358 extending from the base wall 354 to define a generally U-shaped channel 360; and wherein a second portion 338 of the second elongated member 332 is received within the U-shaped recess 352 of the shoulder 342 such that the saddle portion 350 of the second end 348 of the shoulder 342 at least partially surrounds the second portion 338 of the second elongated member 332 and connects the shoulder 342 to the second elongated member 332.

The first axis 314 and the second axis 334 of the load bearing hinge joint 310 are substantially perpendicular to one another when the load bearing hinge joint 210 is in the open configuration. The first elongated member 312 of the load bearing hinge joint 310 is secured to the second elongated member 332 by a fastening 362, welding, bonding, or integrally forming, such that the members 312, 332 are restrained against relative translation while permitting relative rotation therebetween.

In a preferred embodiment, the saddle portion 318 of the first elongated member 312 surrounds less than 360 degrees of a perimeter P of the second elongated member 332. In an open configuration, the load bearing hinge joint 310 includes the first elongated structural member 312 defining a longitudinal first axis 314; the second elongated structural member 332 defining the longitudinal second axis 334 oriented substantially perpendicular to the first axis 314.

The end portion 316 of the first elongated structural member 312 forms the saddle portion 318, the saddle portion 318, is integral to the first elongated structural member 312 and includes the base wall 322 and two opposing side walls 324, 326, extending from the base wall 322 to define the generally U-shaped channel 328.

The U-shaped channel 328 is dimensioned to receive the second elongated structural member 332 in a seated condition, wherein the base wall 322 and opposing side walls 324, 326 support the second elongated structural member 332 while permitting relative rotational movement of the second elongated structural member 332 with respect to the U-shaped channel 328 to enable opening and closing of the structural arm members 312, 332.

The saddle portion 318 mechanically couples the first elongated structural member 312 to the second elongated structural member 332 while permitting relative rotation between the members 312, 332, to enable opening and closing movement.

The base wall 322 of the U-shaped recess 320 is configured to transmit compressive loads from the second elongated structural member 332 to the first elongated structural member 312, and the opposing side walls 324, 326 engage the second elongated structural member 332.

The fastening means 362 pass through the saddle portion 350 and the second elongated structural member 332 to prevent separation of the second elongated structural member 332 from the first elongated structural member 312 and allow pivotal rotation. The U-shaped channel 328 surrounds at least a portion of the perimeter P of the second elongated structural member 332. The saddle portion 318 is integrally formed with the first elongated structural member 312.

It is appreciated that the load bearing hinge joints 10, 210, 310, may be incorporated into an exercise apparatus, such as an exercise pull-up device as shown in FIG. 1. Referring now to FIGS. 1-16C, there is shown the arm members, designated by reference numerals, 12, 28; 212, 228; 312, 332; in the respective embodiments, the arm members including multiple apertures, designated by reference numerals, 68; 252; 368 in the respective embodiments, the apertures formed on opposing sides of the arm members. At least one of the apertures 68; 252; 368 in each of the respective embodiments is positioned to engage or align with a bolt designated by reference numerals, 64; 264; 374 in the respective embodiments, for engagement with a mending brace or other fastening means, designated by reference numerals, 62; 242; 247; 362 of the respective embodiments, such that the engagement defines a rotational stop that limits rotation of the arm members to approximately ninety degrees in an open position and permit rotation of the arm members to a closed position.

It is appreciated by one reasonably skilled in the art that each arm member includes structure configured to cooperate with a fastening means to define a rotational stop at approximately a ninety degree angle. The fastening means may include, but is not limited to, a bolt, mending brace, pin, detent, cam, interference surface, molded stop, or other mechanical limiting structure. The cooperating structure limits rotation of the arm members to approximately ninety degrees in an open position and permits rotation of the arm members to a closed position.

Thus, while there has been shown and described, fundamental novel features of the disclosure as applied to various specific embodiments thereof, it will be understood that various omissions and substitutions and changes in the form and details of the apparatus illustrated, and in their operation, may be made by those skilled in the art without departing from the spirit of the disclosure. For example, it is expressly intended that all combinations of those elements which perform substantially the same function, in substantially the same way, to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore to be limited only as indicated by the scope of the claims appended hereto.

m What is claimed is:

1. A load bearing hinge joint comprising:
a first arm member, wherein the first arm member includes a top surface, a bottom surface, a first side surface, a second side surface, a first end and a second end; wherein the first side surface of the first arm member is opposite to, and at a first distance from, the second side surface of the first arm member;
a second arm member; wherein the second arm member includes a top surface, a bottom surface, a first side surface, a second side surface, a first end and a second end; wherein the first side surface of the second arm member is opposite to, and at a second distance from, the second side surface of the second arm member;
fastening means for pivotally interconnecting the second arm member to the first arm member, wherein a first fastening means positioned on the first side surface of the first arm member connects the first arm member to the second arm member at the first side surface of the second arm member;
a shoulder, wherein the shoulder includes a first end and a second end, and wherein the shoulder is positioned on the top surface of the first arm member, and wherein the second end of the shoulder is positioned at or near the second end of the first arm member is configured to act as a fulcrum to facilitate a pivotal rotation of the second arm member relative to the first arm member at a pivot point.

2. The load bearing hinge joint of claim 2, wherein the first arm member and the shoulder comprise a single unitary body.

3. The load bearing hinge joint of claim 2, wherein the fastening means for pivotally connecting the first arm member to the second arm traverses across a first side of the shoulder.

4. A load bearing hinge joint comprising:
a first elongated member defining a longitudinal first axis and having a first end formed with a first planar joining surface oriented at approximately a forty-five degree angle relative to the first axis;
a second elongated member defining a longitudinal second axis and having a first end portion formed with a second planar joining surface oriented at approximately a forty-five degree angle relative to the second axis;
wherein the first planar joining surface and the second planar joining surface are positioned in abutting engagement when the hinge joint is in an open configuration, such that the first axis and the second axis are oriented substantially perpendicular to one another; and
wherein the abutting planar joining surfaces mechanically couple the first elongated structural member to the second elongated structural member to resist relative translation while permitting rotation about the hinge axis.

5. The load bearing hinge joint of claim 4, further including fastening means for pivotally connecting the first elongated member to the second elongated member.

6. The load bearing hinge joint of claim 5, wherein the fastening means includes an L-shaped configuration having a first portion affixed to the first elongated member and a second portion affixed to the second elongated member, for connecting the first elongated member to the second elongated member, and wherein each portion of the fastening means is affixed to the first and second elongated members over the entirety of the fastening means.

7. The load bearing hinge joint of claim 5, wherein the fastening means is selected from welding, brazing, adhesive bonding, or mechanical fastening and restrains relative translation between the first planar joining surface and the second planar joining surface while allowing relative rotation therebetween.

8. The load bearing hinge joint of claim 4, wherein the planar joining surfaces are configured to define a shear load path for transmitting shear forces parallel to the plane of engagement.

9. The load bearing hinge joint of claim 4, wherein the first elongated member and the second elongated member each have a circular cross-section.

10. The load bearing hinge joint of claim 4, wherein the first planar joining surface includes a projecting tongue and the second planar joining surface includes a corresponding groove configured to interlock when the planar joining surfaces abut, to restrain relative translation while permitting relative rotation between the first and second elongated members.

11. The load-bearing hinge joint of claim 4, wherein the hinge joint is movable to a closed configuration in which the first and second elongated members are rotated relative to one another so that the first and second axes form an acute angle less than 90 degrees, and the planar joining surfaces are separated while the members remain mechanically coupled.

12. A load bearing hinge joint comprising:
a first elongated member extending along a first axis and a second elongated member extending along a second axis oriented at an angle relative to the first axis;
wherein an end portion of the first elongated member includes a saddle portion defining a generally U-shaped recess, and including a base wall and two opposing side walls extending from the base wall to define a generally U-shaped channel; and
wherein the second elongated member is received within the U-shaped recess such that the saddle portion at least partially surrounds a first portion of the second elongated member and connects the first elongated member to the second elongated member.

13. The load bearing hinge joint of claim 12, further including a shoulder, wherein the shoulder includes a first end and a second end, and wherein the shoulder is positioned on a top surface of the first elongated member, and wherein the second end of the shoulder is positioned at or near a second end of the first elongated member and is configured to act as a fulcrum to facilitate a pivotal rotation of the second elongated member relative to the first elongated member at a pivot point.

14. The load bearing hinge joint of claim 13, wherein the second end of the shoulder includes a saddle portion defining a generally U-shaped recess, and including a base wall and two opposing side walls extending from the base wall to define a generally U-shaped channel; and wherein a portion of the second elongated member is received within the U-shaped recess such that the saddle portion of the second end of the shoulder at least partially surrounds a second portion of the second elongated member and connects the shoulder to the second elongated member.

15. The load bearing hinge joint of claim 12, wherein the first axis and the second axis are substantially perpendicular to one another.

16. The load bearing hinge joint of claim 12, wherein the first elongated member is secured to the second elongated member by a fastening, welding, bonding, or integrally forming, such that the members are restrained against relative translation while allowing relative rotation therebetween.

17. The load bearing hinge joint of claim 12, wherein the saddle portion surrounds less than 360 degrees of a perimeter of the second elongated member.
